(19) United States
(12) Patent Application Publication
(10) Pub. No.: US 2003/0231694 A1
(43) Pub. Date: Dec. 18, 2003

(54) Temperature-measuring device

(76) Inventor: Akihiro Ohsawa, Naka-gun (JP)

Correspondence Address: VARNDELL & VARNDELL, PLLC, 106-A S. COLUMBUS ST., ALEXANDRIA, VA, 22314, US

(21) Appl. No.: 10/394,206

(22) Filed: Mar. 24, 2003

(30) Foreign Application Priority Data
Jun. 14, 2002 (JP) 2002-174667

(51) Int. Cl. G01J 5/00

(52) U.S. Cl. 374/129

(57) ABSTRACT

At the time when a temperature of a semiconductor wafer or the like is measured by light without contacting to it, its temperature is measured with high precision without suffering from an influence of changes in temperature of a light source, an influence of a bent degree or the like of an optical fiber or an influence of a displacement of an optical system such as a lens or the like. Light output from the light source is irradiated to the semiconductor wafer through an optical fiber for irradiated light. The light reflected from the semiconductor wafer is output as reflected light through an optical fiber for the reflected light. An optical fiber for reference light having substantially the same route as those of the optical fiber for irradiated light and the optical fiber for reflected light is disposed. The light output from the light source is output as the reference light through the optical fiber for reference light without being irradiated to or reflected from the semiconductor wafer. And, a temperature of the semiconductor wafer is measured according to the reflected light output from the optical fiber for reflected light and the reference light output from the optical fiber for reference light.

### BACKGROUND OF THE INVENTION

1. Field of the Invention

The present invention relates to a temperature-measuring device, and more particularly to a temperature-measuring device suitable for measuring a temperature of a semiconductor wafer in a process of producing semiconductor wafers.

2. Description of the Related Art

Semiconductor wafers are produced through respective processes. Among the respective processes, it is particularly important to measure a temperature of a semiconductor wafer with a high degree of precision having an error of within ±0.1° C. in the resist baking step in order to control the temperature with high accuracy so to improve a yield of semiconductor wafers.

A temperature of a substance can be measured by a variety of methods. One of them measures a temperature of a semiconductor wafer by directly contacting a temperature-measuring instrument such as a thermocouple to it.

But, when the temperature-measuring instrument is directly contacted to the semiconductor wafer, its temperature cannot be measured with high accuracy because a temperature of the semiconductor wafer is variable depending on how the temperature-measuring instrument is contacted and an error is caused. Therefore, this measuring method which directly contacts the temperature-measuring instrument to the semiconductor wafer cannot be used to measure a temperature of the semiconductor wafer.

A radiation thermometer may be used to directly measure a temperature of the semiconductor wafer without contacting to it.

But, the semiconductor wafer hardly radiates at 200° C. or less, so that the radiation thermometer is not suitable to measure a temperature of the semiconductor wafer in a baking step conducted at a temperature lower than 200° C.

Therefore, a non-contact temperature-measuring method using light is being tried. It irradiates light emitted from a light source to a semiconductor wafer to reflect therefrom via an optical system such as an optical fiber, a lens and the like to detect an intensity of the irradiated light and an intensity of the reflected light so to determine a reflectance of light and measures a temperature of a semiconductor according to the reflectance of light. This method is based on the characteristic of the substance to be measured that its refractive index is variable depending on a temperature. It determines a reflectance from the intensity of the irradiated light and the intensity of the reflected light, calculates the refractive index from Snell's law, applies the refractive index to a predetermined relationship between a refractive index and a temperature to determine a temperature.

But, such a non-contact temperature-measuring method using light could not measure a temperature with high accuracy because of the following reasons.

(1) The light intensity of the light source is largely variable depending on a change in temperature of the light source. Therefore, the intensity of irradiated light varies, and the reflected light intensity also varies accordingly. The change in the intensity of reflected light causes to change a temperature of the semiconductor wafer in appearance.

(2) The light emitted from the light source is introduced into the optical fiber and irradiated as irradiated light to the semiconductor wafer, but the numerical aperture number for the optical fiber is variable depending on a degree of bending of the optical fiber and a change in temperature of the optical fiber. Therefore, the irradiated light intensity is varied, and the reflected light intensity is also varied accordingly. And, the variance of the reflected light intensity causes to change the temperature of the semiconductor wafer in appearance.

(3) An incident angle or the like of light to the semiconductor wafer is varied by a displacement or the like of the optical system such as a lens. Therefore, the reflected light intensity is varied, and a temperature of the semiconductor wafer is varied in appearance.

Conventionally, there is a method of correcting a temperature error by dividing light into light to be irradiated to the semiconductor wafer and light for monitoring by a beam splitter disposed just behind the light source and detecting a change in the intensity of light for monitoring to detect a change in temperature of the semiconductor wafer in appearance. A similar invention is described in, for example, Japanese Patent Application Laid-Open Publication No. 2001-4452.

The above method can detect a change in intensity, namely a change in light intensity of the light source, before the division of light by the beam splitter but cannot detect a change in intensity of the irradiated light which has come through the optical fiber after the division of the light by the beam splitter. It can remedy the above problem (1) but cannot remedy the above problems (2) and (3).

The present invention was achieved under the above-described circumstances and aims to remedy all the above problems (1) to (3) in measuring a temperature by light without contacting.

### SUMMARY OF THE INVENTION

The present invention provides a temperature-measuring device, comprising light guides (43, 44) for irradiated and reflected light, for irradiating light output from a light source (6) to an object of temperature measurement (2) and for outputting light reflected from the object of temperature measurement (2) as reflected light; and a light guide (45) for reference light having substantially a same route as the light guides (43, 44) for irradiated and reflected light, for outputting light output from the light source (6) as reference light without irradiating to or reflecting from the object of temperature measurement (2), wherein a temperature of the object of temperature measurement (2) is measured according to the reflected light output from the light guides (43, 44) for irradiated and reflected light and the reference light output from the light guide (45) for reference light.

As shown in FIG. 1, the light guides 43, 44 for irradiated and reflected light and the light guide 45 for reference light have substantially the same route, and they are different from each other on the point that the light guides 43, 44 for reflected light are light guides for irradiation and reflection of light to and from the semiconductor wafer 2, and the light guide 45 for reference light is a light guide not for irradiation or reflection of light to or from the semiconductor wafer 2. The light guides 43, 44 for irradiated and reflected light and the light guide 45 for reference light may be configured of separate optical fibers as shown in FIG. 2. It may also be configured as shown in FIG. 3 that the light guide for irradiation to the semiconductor wafer is formed of a common optical fiber 43 and the light guide for light after the reflection from the semiconductor wafer is formed of separate optical fibers 44, 45.

A temperature of the semiconductor wafer 2 is measured according to the reflected light output from the light guides 43, 44 for irradiated and reflected light and the reference light output from the light guide 45 for reference light. Specifically, intensity Lw of the reflected light and intensity Lr of the reference light are detected by a photodetector 7, and their ratio R is computed by a computing unit 8 according to the intensity Lw of the reflected light and the intensity Lr of the reference light by the following expression (1).

R=Lw/Lr (1)

And, temperature T of the semiconductor wafer 2 is calculated using the ratio R by the following expression (2).

T=−7.85R\hat{ }2+1751R−97400 (where, “\hat{ }2” indicates a square) (2)

The light guides 43, 44 for irradiated and reflected light and the light guide 45 for reference light have substantially the same route, so that a variation of the irradiated light intensity due to a change in temperature of the light source 6 and a variation of the irradiated light intensity due to a bent degree of the optical fiber and a change in temperature are cancelled by determining a ratio of the intensity Lw of the reflected light and the intensity Lr of the reference light from the above expression (1). And, the light guides 43, 44 for irradiated and reflected light are light guides for irradiation and reflection of light to and from the semiconductor wafer 2, while the light guide 45 for reference light is a light guide not for irradiation or reflection of light to or from the semiconductor wafer 2. Because of the above difference, only the reflectance of light having been removed the above variation can be extracted by determining a ratio between the intensity Lw of the reflected light and the intensity Lr of the reference light by the above expression (1). Therefore, the temperature T of the semiconductor wafer 2 can be determined with high precision from the above expression (2) without suffering from an influence of a change in temperature of the light source 6, an influence of a bent degree of the optical fiber or an influence of a displacement of the optical system such as a lens or the like.

### BRIEF DESCRIPTION OF THE DRAWINGS

FIG. 1 is a structure diagram showing a temperature-measuring device according to an embodiment of the present invention;

FIG. 2 is a diagram showing the internal structure of a recessed substrate shown in FIG. 1;

FIG. 3 is a diagram showing a structure different from FIG. 2; and

FIGS. 4A, 4B and 4C are diagrams showing examples of positional relationships between the semiconductor wafer and the recessed substrate.

### DESCRIPTION OF THE PREFERRED EMBODIMENTS

Embodiments of the temperature-measuring device according to the present invention will be described with reference to the accompanying drawings. It is to be understood that the embodiments cover a device for measuring a temperature of a semiconductor water (silicon wafer) in a resist baking step.

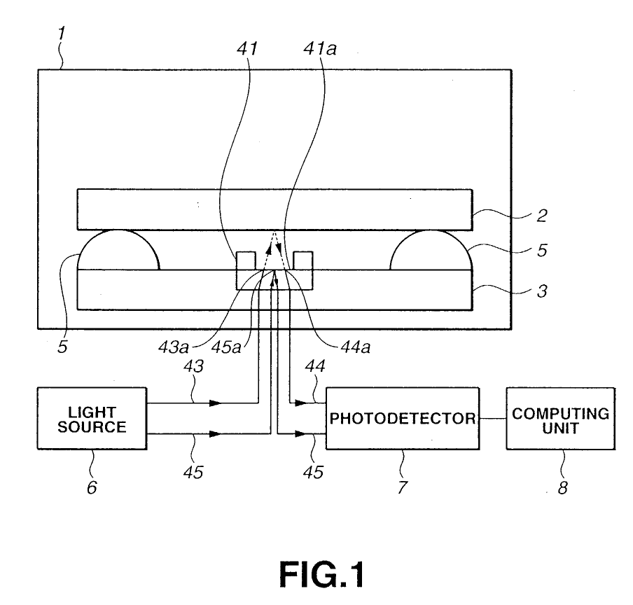

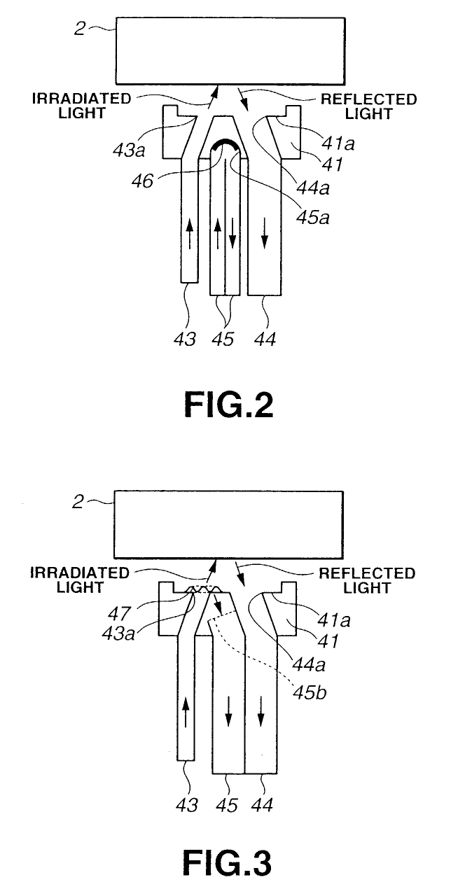

FIG. 1 shows a structure of the temperature-measuring device of an embodiment. FIG. 2 shows an expanded inside structure of a recessed substrate 41 shown in FIG. 1.

The light source 6 outputs light having a prescribed intensity and, for example, an LED or an LD (semiconductor laser light source) is used. As the light source 6, any unit can be used as far as it can reflect light from the semiconductor wafer 2.

A baking plate 3 is disposed within a chamber 1. A temperature of the baking plate 3 is controlled by an unshown controller based on as a feedback amount a temperature of the semiconductor wafer 2 calculated by and output from the computing unit 8 as described later. Plural gap pins 5 are disposed on the heating surface of the baking plate 3, which is at an upper side in the drawing. The semiconductor wafer 2 is supported by the plural gap pins 5 at a height (to have a gap) of about 50 to 150 μm from the heating surface of the baking plate 3. The gap pins 5 are made of ceramics or the like and precisely machined with a precision of about 10 μm or less.

The recessed substrate 41 is disposed on the heating surface of the baking plate 3 a prescribed distance away from the bottom surface of the semiconductor wafer 2.

The two optical fibers 43, 45 have their one ends connected to the light source 6, and light emitted from the light source 6 is introduced into the two optical fibers 43, 45. The optical fiber 43 configures a light guide for irradiated light. The other end of the optical fiber 43 for irradiated light is connected to the recessed substrate 41. An output port 43a of the optical fiber 43 for irradiated light is open to a recess bottom 41a of the recessed substrate 41.

The optical fiber 45 configures a light guide for reference light, and the optical fiber 45 for reference light is connected to and bent within the recessed substrate 41. The other end of the optical fiber 45 for reference light is connected to the photodetector 7.

The optical fiber 44 configures a light guide for reflected light and one end of the optical fiber 44 for reflected light is connected to the recessed substrate 41. A feed port 44a of the optical fiber 44 for reflected light is open to the recess bottom 41a of the recessed substrate 41. The other end of the optical fiber 44 for reflected light is connected to the photodetector 7.

The optical fiber 43 for irradiated light, the optical fiber 44 for reflected light and the optical fiber 45 for reference light are disposed to make the light passing through their interiors trace substantially the same route.

FIG. 2 shows the inside structure of the recessed substrate 41.

The recessed substrate 41 is made of an insulator such as quartz, silicon or ceramic, the optical fiber 43 for irradiated light and the optical fiber 44 for reflected light are fixed their one ends in the interior, and a bent portion of the optical fiber 45 for reference light is fixed in the interior.

The optical fiber 43 for irradiated light and the optical fiber 44 for reflected light are bent to a prescribed angle within the recessed substrate 41 so that light emitted from the output port 43a of the optical fiber 43 for irradiated light is irradiated to the semiconductor wafer 2, and light reflected from the semiconductor wafer 2 is introduced into the feed port 44a of the optical fiber 44 for reflected light.

The optical fiber 45 for reference light is bent within the recessed substrate 41 so that the reference light passing through the optical fiber 45 traces the same route as those of the irradiated light and the reflected light passing through the optical fiber 43 for irradiated light and the optical fiber 44 for reflected light. The optical fiber 45 for reference light is bent in the vicinity of the output port 43a and the feed port 44a. A bent portion 45a of the optical fiber 45 for reference light is formed to have a total reflection mirror film 46 for total reflection of the reference light.

The recess bottom 41a of the recessed substrate 41 is set on the same plane as the surface of the baking plate 3.

Therefore, the light introduced from the light source 6 into the optical fiber 43 for irradiated light is emitted from the output port 43a of the optical fiber 43 for irradiated light and irradiated as the irradiated light to the semiconductor wafer 2. The reflected light reflected from the semiconductor wafer 2 is introduced into the feed port 44a of the optical fiber 44 for reflected light and introduced into the photodetector 7 through the optical fiber 44 for reflected light.

And, the reference light introduced from the light source 6 into the optical fiber 45 for reference light traces the same route as the irradiated light passing through the optical fiber 43 for irradiated light to reach the bent portion 45a. The reference light having reached the bent portion 45a is totally reflected from a total reflection mirror film 46 within the optical fiber 45 for reference light, traces the same route as that of the reflected light passing through the optical fiber 44 for reflected light and enters into the photodetector 7. Specifically, the reference light passing through the optical fiber 45 for reference light traces the same route as those of the irradiated light and the reflected light passing through the optical fiber 43 for irradiated light and the optical fiber 44 for reflected light and enters as the reference light into the photodetector 7 without irradiating the semiconductor wafer 2 or reflecting from the semiconductor wafer 2.

In FIG. 2, the routes through which the light reaches from the light source 6 to the recessed substrate 41 are configured of the separate optical fibers 43, 45. But, the routes through which the light reaches from the light source 6 to the recessed substrate 41 may be configured of the common optical fiber 43 as shown in FIG. 3.

In the configuration of FIG. 3, the common optical fiber 43 is disposed as a route through which the irradiated light and the reference light pass, one end of the common optical fiber 43 is connected to the light source 6, and the other end is connected to the recessed substrate 41. The beam splitter 47 is disposed at the common output port 43a of the common optical fiber 43. The beam splitter 47 is formed at the output port 43a of the common optical fiber 43.

Meanwhile, one end of the optical fiber 45 for reference light is connected to the recessed substrate 41 and the other end is connected to the photodetector 7. The optical fiber 45 for reference light is bent within the recessed substrate 41 in the same manner as the optical fiber 44 for reflected light so that the light reflected from the beam splitter 47 is introduced into a feed port 45b.

Therefore, the light introduced from the light source 6 into the common optical fiber 43 is partly passed through the beam splitter 47 and emitted from the output port 43a of the common optical fiber 43 and irradiated as the irradiated light to the semiconductor wafer 2. The reflected light reflected from the semiconductor wafer 2 is introduced into the feed port 44a of the optical fiber 44 for reflected light and introduced into the photodetector 7 through the optical fiber 44 for reflected light.

In the light introduced from the light source 6 into the optical fiber 43, the light not having passed through the beam splitter 47 is reflected from the beam splitter 47, introduced as the reference light into the feed port 45b of the optical fiber 45 for reference light and introduced into the photodetector 7 through the optical fiber 44 for reference light.

Specifically, the reference light passing through the common optical fiber 43 and the optical fiber 45 for reference light traces the same routes as those of the irradiated light and the reflected light passing through the optical fiber 43 for irradiated light and the optical fiber 44 for reflected light and is introduced as the reference light into the photodetector 7 without irradiating the semiconductor wafer 2 or being reflected from the semiconductor wafer 2.

According to the structure of FIG. 3, the optical fiber 43 running from the light source 6 to the recessed substrate 41 can be made common, so that the number of parts and costs can be reduced as compared with the structure of FIG. 2.

The photodetector 7 shown in FIG. 1 detects the intensity Lw of the reflected light output from the optical fiber 44 for reflected light and the intensity Lr of the reference light output from the optical fiber 45 for reference light.

The computing unit 8 calculates the ratio R of the intensity Lw of the reflected light and the intensity Lr of the reference light by the following expression (1):

R=Lw/Lr (1)

And, the temperature T of the semiconductor wafer 2 is calculated using the above ratio R by the following expression (2).

T=−7.85R\hat{ }2+1751R−97400 (where, “\hat{ }2” indicates a square) (2)

The temperature T calculated by the computing unit 8 is input to the above-described controller and used as a feedback amount to control the temperature of the baking plate 3.

Here, the optical fiber 43 for irradiated light and the optical fiber 44 for reflected light through which the irradiated light and the reflected light pass (the common optical fiber 43 and the optical fiber 44 for reflected light in the configuration of FIG. 3) and the optical fiber 45 for reference light (the common optical fiber 43 and the optical fiber 45 for reference light in the structure of FIG. 3) are common as the route through which light passes, so that a variation of irradiated light intensity due to a temperature change of the light source 6 and a variation of irradiated light intensity due to a bent degree of the optical fiber are cancelled each other by determining a ratio between the intensity Lw of the reflected light and the intensity Lr of the reference light in the expression (1). And, the reflected light is light having a history that it was irradiated to and reflected from the semiconductor wafer 2, while the reference light is light having a history that it was not irradiated to or reflected from the semiconductor wafer. By determining a ratio between the intensity Lw of the reflected light and the intensity Lr of the reference light by the above expression (1), only the reflectance of the light which is removed the above variation can be extracted. Therefore, the temperature T of the semiconductor wafer 2 can be determined with high precision from the above expression (2) without suffering from an influence of a temperature change of the light source 6, an influence of the bent degree of the optical fiber, or an influence of a displacement of the optical system such as a lens or the like.

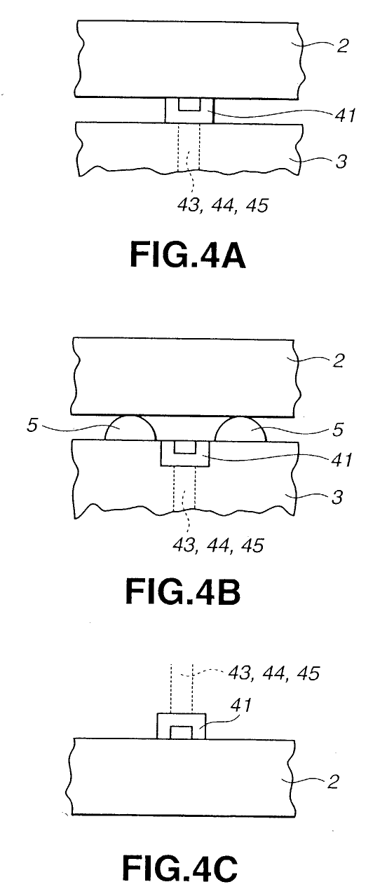

In FIG. 1, the recessed substrate 41 is disposed independent of the gap pins 5 but may be configured to also serve as the gap pins 5 so to support the semiconductor wafer 2 as shown in FIG. 4A.

In the structure of FIG. 1 and the structure of FIG. 4A, distances from the output port 43a and the feed port 44a formed on the recess bottom 41a of the recessed substrate 41 to the semiconductor wafer 2 are approximately 50 μm to 150 μm and very close.

Therefore, the optical fiber having a diameter of about 10 μm is used as the optical fiber 43 for irradiated light (the common optical fiber 43 in the structure of FIG. 3), and the optical fiber having a larger diameter of about 50 to 100 μm is used as the optical fiber 44 for reflected light, so that the light reflected from the semiconductor wafer 2 can be concentrated on the feed port 44a of the optical fiber 44 for reflected light without fail. Therefore, the optical system such as a lens becomes unnecessary.

Besides, when the recessed substrate 41 is formed of a material such as quartz having a small thermal expansion, the recessed substrate 41 can be prevented from being deformed even if the semiconductor wafer 2 suffers from temperature agitation. Therefore, changes in the bent angles of the optical fibers 43, 44 within the recessed substrate 41 and the depth of the recess of the recessed substrate 41 are small, and the reflected light can be concentrated on the feed port 44a of the optical fiber 44 for reflected light without leakage.

According to the embodiment described above, the reflected light can be concentrated on the optical fiber 44 for reflected light with reliability without using the optical system such as a lens, so that the temperature T can be measured with high precision without suffering from an influence of a displacement of the optical system such as a lens.

The semiconductor wafer 2 is assumed as the object of temperature measurement in the embodiment, and the invention can also be applied to measurement of a temperature of another subject.

The recessed substrate 41 may be disposed within the baking plate 3 as shown in FIG. 4B or may be disposed on the semiconductor wafer 2 as shown in FIG. 4C.

In the embodiment, the intensity Lw of the reflected light and the intensity Lr of the reference light are detected to measure the temperature T. But, it is just an example, and it is sufficient by detecting an optical parameter capable of measuring the temperature T. For example, an amount of light and a wavelength may be detected instead of the light intensity to measure the temperature T according to such optical parameters. In the above-described embodiment, the temperature T is measured by determining the ratio R of the intensity Lw of the reflected light and the intensity Lr of the reference light as indicated by the expressions (1) and (2). But, the temperature T may be measured by determining a difference between the reflected light and the reference light instead of determining the ratio between the reflected light and the reference light.

The substrate 41 has a recessed shape to surround the plane where light is emitted or introduced in the embodiment, but it is not a limited requirement and may be configured to make the plane for emitting or introducing light fully flat or spherical.

What is claimed is:

1. A temperature-measuring device, comprising:
light guides for irradiated and reflected light, for irradiating light output from a light source to an object of temperature measurement and for outputting light reflected from the object of temperature measurement as reflected light; and
a light guide for reference light having substantially a same route as the light guides for irradiated and reflected light, for outputting the light output from the light source as reference light without irradiating to or reflecting from the object of temperature measurement, wherein:
a temperature of the object of temperature measurement is measured according to the reflected light output from the light guides for irradiated and the reflected light and the reference light output from the light guide for reference light.
